(19) United States
(12) Patent Application Publication
(10) Pub. No.: US 2025/0156588 A1
(43) Pub. Date: May 15, 2025

(54) ELECTRONIC DEVICE AND OPERATING METHOD OF THE SAME

(71) Applicant: ICTK CO., LTD., Seoul (KR)

(72) Inventors: Bong Ho KANG, Seoul (KR); Kwang Cho SHIN, Seoul (KR); Hyoung Sub SHIM, Seoul (KR)

(73) Assignee: ICTK CO., LTD., Seoul (KR)

(21) Appl. No.: 18/946,991

(22) Filed: Nov. 14, 2024

(30) Foreign Application Priority Data
Nov. 14, 2023 (KR) 10-2023-0157327

(51) Int. Cl. G06F 21/85; G06F 13/40

(52) U.S. Cl. CPC G06F 21/85; G06F 13/4027; G06F 2213/0016

(57) ABSTRACT

Provided are an electronic device and an operating method of the same.

### CROSS-REFERENCE TO RELATED APPLICATION

This application claims the benefit of priority of Korean Patent Application No. 10-2023-0157327, filed on Nov. 14, 2023, the disclosure of which is incorporated herein by reference in its entirety.

### BACKGROUND

### 1. Field of the Invention

The present invention relates to a security method, a security module, and an electronic device including the same.

### 2. Discussion of Related Art

Internet of things (IoT) environments are expected to proliferate, in which not only existing communication devices, such as smartphones and tablet personal computers (PCs), but also various objects, such as a variety of sensors, home appliances, automobiles, and the like, are connected to the network. In such IoT environments, security and authentication are recognized as the most important technologies.

Also, with the development of technology and the Internet, various embedded platforms and sensors have been developed. Accordingly, the IoT society has arrived, and in response, organizations and companies are developing open source-based hardware platforms for IoT services as general-purpose IoT devices.

The foregoing security and authentication are understood as including the authentication of things or devices, the security of data stored in devices, and/or the protection of information transmitted or received by devices.

Data required for connecting communication devices, such as IoT devices and the like, to the network is verified through a subscriber identity module (SIM). In this regard, a method is under development to support multi-subscribers and technically subscribe to several communication service providers. For example, communication devices are switching from universal subscriber identity modules (USIMs) to electronic subscriber identity modules (eSIMs).

Further, with regard to security, root of trust (RoT) security chips are used as important tools for enhancing the security of devices. For this reason, RoT security chips are being used to enhance device security and protect important data of devices. In addition, attempts are being made to apply a physically unclonable function (PUF) to such an RoT security chip. Such a PUF may provide an unpredictable digital value. Even when an accurate PUF manufacturing process is given and PUFs are manufactured through the same process, the individual PUFs provide different digital values. A PUF may also be referred to as a “physical one-way function (POWF) practically impossible to duplicate.”

The unduplicable characteristic of a PUF may be used to generate a device identifier for security and/or authentication. For example, a PUF may be used for providing a unique key to distinguish devices from one another.

As described above, with the development of communication devices, demands for subscriber identification and demands for authentication and security based on a security chip are increasing together, and it is necessary to improve security and convenience.

### SUMMARY OF THE INVENTION

The present invention is directed to providing an electronic device that has an interface part including interfaces having different protocols in the same chip, that is, combined in hardware, and thus is inexpensive and simultaneously achieves security enhancement and subscriber authentication, and an operating method of the same.

The present invention is also directed to providing an electronic device that simultaneously achieves security and subscriber authentication using a physically unclonable value and thus is easy to manufacture, and an operating method of the same.

The present invention is also directed to compacting a device by providing an interface compatible with an identification module for subscriber authentication and a root of trust (RoT) security module in which the identification module and the security module are not separated into independent chips or devices.

Objects to be achieved by embodiments of the present invention are not limited thereto, and solutions described below and purposes or effects that may be found in embodiments disclosed below may also be included in the objects.

According to an aspect of the present invention, there is provided an electronic device including a memory, an interface part including a first interface and a second interface having different connection methods, a processor operationally connected to at least one of the interface part and the memory, an identification module connected to the second interface to perform subscriber authentication, and a security module connected to the first interface on the basis of a generated unique identification key to perform a security function.

The security module may include a physically unclonable function (PUF) chip configured to generate the unique identification key.

The identification module and the security module may operate independently of each other.

The processor may perform subscriber authentication after a certain time when the security function is performed.

The first interface may include an inter-integrated circuit (I²C) interface and a serial peripheral interface (SPI).

The second interface may include an International Organization for Standardization (ISO) interface and an International Electrotechnical Commission (IEC) interface.

The processor may turn on or off only operation of at least one of the identification module and the security module.

The processor may transmit a received first packet to a past module that has executed a packet received immediately before the first packet between the identification module and the security module.

The processor may transmit a received first packet to a first module which is any one of the identification module and the security module in order of priority.

When the first module does not operate, the processor may transmit a second packet subsequent to the first packet to a second module or transmit a re-request for the first packet to an external device.

The processor may transmit a received first packet to any one of the identification module and the security module corresponding to an initial packet for the first packet.

According to another aspect of the present invention, there is provided an operating method of an electronic device, the method including receiving a control signal for at least one of an identification function and a security function through an interface part, transmitting the control signal to a security module, and when the security module does not operate, transmitting the control signal to an identification module after a certain time elapses.

The interface part may include a first interface and a second interface having different connection methods.

The security module may include a PUF chip configured to generate a unique identification key.

The identification module and the security module may operate independently of each other.

The transmitting of the control signal to the identification module may include performing subscriber authentication by transmitting the control signal to the identification module after the certain time elapses.

The first interface may include an I²C interface and an SPI.

The second interface may include an ISO interface and an IEC interface.

The method may further include turning on or off only operation of at least one of the identification module and the security module.

According to another aspect of the present invention, there is provided an operating method of an electronic device, the operating method including receiving a control signal for at least one of an identification function and a security function through an interface part and determining whether to transmit the control signal to a first module which is one of an identification module for performing the identification function and a security module for performing the security function.

The determining of whether to transmit the control signal may include transmitting a received first packet to the first module which is the one of the identification module and the security module in order of priority and, when the first module does not operate, transmitting a second packet subsequent to the first packet to a second module or transmitting a re-request for the first packet to an external device.

The determining of whether to transmit the control signal may include transmitting a received first packet to the one of the identification module and the security module corresponding to an initial packet for the first packet.

The determining of whether to transmit the control signal may include transmitting a received first packet to the one of the identification module and the security module corresponding to an initial packet for the first packet.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram illustrating an electronic device according to an exemplary embodiment of the present invention;

FIG. 2 is a diagram illustrating an operation of an electronic device according to an exemplary embodiment of the present invention;

FIG. 3 is a diagram illustrating another operation of an electronic device according to an exemplary embodiment of the present invention; and

FIG. 4 is a flowchart illustrating an operating method of an electronic device according to an exemplary embodiment of the present invention.

### DETAILED DESCRIPTION OF EXEMPLARY EMBODIMENTS

Since the present invention can be variously modified and have several embodiments, specific embodiments will be illustrated in the drawings and described. However, this is not intended to limit the present invention to the specific embodiments, and it is to be understood that the present invention includes all modifications, equivalents, and substitutions within the spirit and technical scope of the present invention.

Terms including ordinal numbers, such as “second,” “first,” and the like, may be used for describing various components, but the components are not limited by the terms. The terms are only used for the purpose of distinguishing one component from another. For example, a second component may be named a first component without departing from the scope of the present invention, and a first component may likewise be named a second component. The term “and/or” includes any one or a combination of a plurality of related stated items.

When a first component is referred to as being “connected” or “coupled” to a second component, the first component may be directly connected or coupled to the second component, or an intermediate component may be therebetween. On the other hand, when a first component is referred to as being “directly connected” or “directly coupled” to a second component, there is no intermediate component therebetween.

Terminology used in this specification is used only for describing specific embodiments and is not intended to limit the present invention. The singular forms include the plural forms as well unless the context clearly indicates otherwise. In this specification, the terms “comprise,” “comprising,” “include,” “including,” “have,” “having,” and the like indicate the presence of features, integers, steps, operations, components, parts, or combinations thereof stated herein and do not preclude the possibility of presence or addition of one or more other features, integers, steps, operations, components, parts, or combinations thereof.

Unless otherwise defined, all terms including technical or scientific terms used herein have the same meaning as generally understood by those of ordinary skill in the art. Terms defined in generally used dictionaries are construed as having the same meaning as would be construed in the context of the related art. Unless defined clearly in this specification, the terms are not interpreted in an ideal or excessively formal sense.

Some embodiments may be represented by functional blocks and various processing operations. All or some of the functional blocks may be implemented by various hardware and/or software elements that perform specific functions. For example, functional blocks of the present disclosure may be implemented by one or more processors or microprocessors or circuit elements for performing intended functions. Also, for example, functional blocks of the present disclosure may be implemented in various programming or scripting languages. The functional blocks may be implemented as algorithms that are executed on one or more processors. The present disclosure may employ the related art for electronic environment settings, signal processing, data processing, and/or the like. The terms “module,” “element,” and the like may be used in a broad sense and are not limited to mechanical and physical elements.

Hereinafter, exemplary embodiments of the present invention will be described in detail with reference to the accompanying drawings. Throughout the drawings, like reference numerals refer to like components, and duplicate descriptions thereof will be omitted.

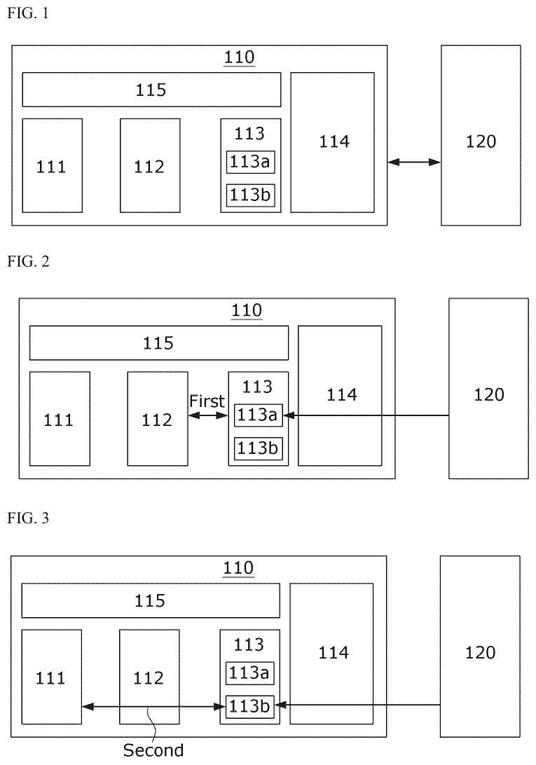

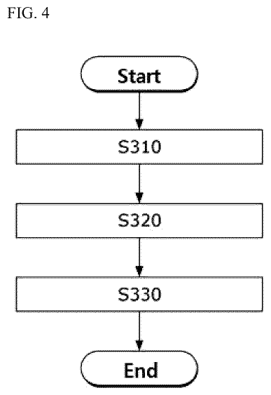

FIG. 1 is a diagram illustrating an electronic device according to an exemplary embodiment of the present invention. FIG. 2 is a diagram illustrating an operation of an electronic device according to an exemplary embodiment of the present invention. FIG. 3 is a diagram illustrating another operation of an electronic device according to an exemplary embodiment of the present invention. FIG. 4 is a flowchart illustrating an operating method of an electronic device according to an exemplary embodiment of the present invention.

Referring to FIGS. 1 and 2, an electronic device 110 according to an exemplary embodiment may include an identification module 111, a security module 112, an interface part 113, a general processor 114, and a memory 115. The electronic device 110 may generate a key for security (e.g., a unique identification key) through the security module 112 and establish a security channel for communication with another device (e.g., an external device or a server) on the basis of the generated key. Further, the electronic device 110 may perform a subscriber authentication function through the identification module 111.

According to an exemplary embodiment, the electronic device 110 may be a chip or a system on chip (SoC) installed in a device to be described below or include various computing devices, such as a smartphone, a tablet personal computer (PC), a laptop computer, a desktop PC, and the like, various wearable devices, such as a smart watch, smart glasses, and the like, various home appliances, such as a smart speaker, a smart television (TV), a smart refrigerator, and the like, a smart identification (ID), a smart credit card, a data storage device, a smart vehicle, an Internet of things (IoT) device, and the like.

According to an exemplary embodiment, the electronic device 110 may perform operations according to a request received from an external device 120. The electronic device 110 may generate a key for security (e.g., a unique identification key) through the security module 112 and establish a security channel for communication with another device (e.g., an external device or a server) on the basis of the generated key. Further, the electronic device 110 may perform a subscriber authentication function through the identification module 111.

According to an exemplary embodiment, the electronic device 110 may be a chip or an SoC installed in the device to be described below or include various computing devices, such as a smartphone, a tablet PC, a laptop computer, a desktop PC, and the like, various wearable devices, such as a smart watch, smart glasses, and the like, various home appliances, such as a smart speaker, a smart TV, a smart refrigerator, and the like, a smart ID, a smart credit card, a data storage device, a smart vehicle, an Internet of things (IoT) device, and the like.

The identification module 111 may perform subscriber authentication. As an example, the identification module 111 may perform a subscriber authentication procedure in communication with the external device 120. For example, the identification module 111 may be a subscriber identity module (SIM). In particular, the identification module 111 may be connected to the interface part 113 or a second interface 113b and communicate with a processor or the like of an external device or another device.

The security module 112 may perform a security operation. For example, the security module 112 may perform a security operation on the basis of a unique identification key generated on the basis of a physically unclonable function (PUF). According to an exemplary embodiment, the security module 112 may include a PUF or a PUF chip. According to an exemplary embodiment, the security module 112 may include a PUF for providing an unpredictable digital value and an operator (e.g., a processor or the like) for performing computational operations. The PUF may provide an unpredictable digital value which is determined on the basis of a manufacturing process variation. Even when PUFs are accurately manufactured in the same manufacturing process, digital values provided by the PUFs are different due to process variations. Accordingly, the PUF may also be referred to as a “physical one-way function (POWF) practically impossible to duplicate.” The PUF may be used to generate an authentication key for security and/or device authentication. For example, the PUF may be used for providing a unique key to distinguish devices from one another. The security module 112 may be packaged with the identification module 111. In this way, the stability of the electronic device 110 can be improved.

The security module 112 may be used as a hardware root of trust (RoT) or may be an RoT module. Accordingly, the security module 112 may encrypt firmware binaries and an operating system (OS) using a unique identification key generated through the foregoing PUF. In this way, the security module 112 may perform secure booting, secure update, server authentication, and the like. In other words, it is possible to prevent attackers from easily changing firmware binaries and OSs. The security module 112 may be connected to the interface part 113 or a first interface 113a to communicate with the external device 120 and the like.

Further, when a security operation is performed through encryption employing the unique identification key, the electronic device 110 or the security module 112 may achieve security (e.g., secured communication) with the external device 120.

Also, the PUF may provide an unpredictable digital value which is determined on the basis of a process variation of the manufacturing process. The PUF may provide the unpredictable digital value. Even when individual PUFs are accurately manufactured in the same manufacturing process, digital values provided by the PUFs may differ from each other due to process variations. Accordingly, the PUF may also be referred to as a “POWF practically impossible to duplicate.” The PUF may be used to generate an authentication key for security, communication, and/or device authentication. For example, the PUF may be used for providing a unique key to distinguish devices from one another. A PUF and a method of implementing the same are disclosed in Korean Patent No. 10-1139630, the disclosure of which is incorporated herein by reference.

There are several embodiments of the present invention for implementing a PUF. Specifically, a PUF according to an exemplary embodiment may be implemented by vias disposed between conductive layers or inter-layer contacts.

Also, a PUF may be implemented in a part of a semiconductor. Accordingly, it may be difficult to identify the accurate location of a PUF through external observation. In other words, since there are a huge number of vias or inter-layer contacts in a semiconductor circuit, it is difficult to determine which part is used as a PUF, which is a favorable security effect.

As described above, a PUF may be implemented according to various embodiments. For example, a PUF may be implemented by vias or contacts disposed between conductive layers. In this case, the PUF may be located on a single element called a security module. According to an exemplary embodiment, a PUF may be located in a security module, and the security module may include a plurality of PUF-based circuits.

Further, a plurality of PUF vias may exist in a security module or a single element of the security module. For example, the number of the plurality of PUF vias may be a few, tens, or hundreds or more. In this case, each PUF via may provide a certain output. For example, each PUF via may provide an output of 0 or 1 (e.g., a digital output). In other words, a single bit may be output from each PUF-based element (e.g., a passive element). In this way, the plurality of circuits may be PUF (e.g., PUF via)-based circuits which have various outputs according to a combination of a plurality of PUF vias.

Each of the plurality of circuits may correspond to a pre-selection circuit. In other words, each of the plurality of circuits may correspond to a verified pre-selection circuit. Such a pre-selection circuit may be a circuit of which the randomness and uniqueness are verified in advance among a plurality of circuits which are combinations of elements.

The plurality of circuits may include at least one or more connections of elements (e.g., vias and contacts) implemented as PUFs in the security module. In other words, each of the plurality of circuits may be a connection or combination of one or more elements among the elements (e.g., vias and contacts) implemented as the PUFs in the security module. Accordingly, the plurality of circuits are verified in advance, and the randomness and uniqueness can be ensured.

Also, according to an exemplary embodiment, a plurality of circuits in a single element (e.g., a security module) may have different outputs due to PUFs. In other words, the plurality of circuits may have different connections of one or more elements among elements (e.g., vias and contacts) implemented as the PUFs in the security module and thus can provide different outputs.

The security module 112 may not perform encryption processing using a PUF-based challenge-response pair with the identification module 111. According to an exemplary embodiment, a PUF of the security module 112 may be an inborn physical ID. Accordingly, the security module 112 may encrypt firmware binaries and the OS using an identification key according to a packet or data received through the first interface 113a and transmit the encrypted data.

The interface part 113 may include a plurality of connective devices. The interface part 113 may include the first interface 113a and the second interface 113b.

The first interface 113a and the second interface 113b may be connected independently of each other. For example, the first interface 113a may include an inter-integrated circuit (I²C) interface and a serial peripheral interface (SPI). The second interface 113b may include an International Organization for Standardization (ISO) interface (ISO 7816) and an International Electrotechnical Commission (IEC) interface. According to the different connection methods or protocols, the first interface 113a may be connected to the security module 112, and the second interface 113b may be connected to the identification module 111. In this way, according to an exemplary embodiment, the identification module 111 and the security module 112 can perform operations independently of each other. Alternatively, the interface part 113 may include all of the protocols of the first interface 113a and the protocols of the second interface 113b. For example, the interface part 113 may be configured to provide the I²C interface and the SPI through 7816 which is an electronic subscriber identity module (eSIM) interface and an RoT interface.

The processor 114 is a computation device for processing general operations performed in the electronic device 110 and may include, for example, a central processing unit (CPU), a microcontroller unit (MCU), or the like. The processor 114 may receive information on the establishment of a security channel between the security module 112 and the server 200. After the channel is established, the processor 114 may also transmit data to the server 200.

The processor 114 may be operationally connected to at least one of the interface part 113 and the memory 115. When a control signal for at least one of an identification function and a security function is received through the interface part 113, the processor 114 may transmit the control signal to the security module 112 and the identification module 111.

According to an exemplary embodiment, the processor 114 may transmit a control signal to the security module 112 first. When the security module 112 does not operate, the processor 114 may transmit the control signal to the identification module 111 after a certain time elapses. In other words, when a certain control signal is applied to the interface part 113, the processor 114 may provide the control signal to the security module 112 first to attempt a security operation. After that, the processor 114 may provide the control signal to the identification module 111 to attempt subscriber authentication.

Further, the processor 114 may turn on or off only operation of at least one of the identification module 111 and the security module 112. Accordingly, it is possible to efficiently perform a desired operation. For example, after a secured communication channel is established through the security module 112, the processor 114 may only perform a subscriber authentication operation. Also, when a secured communication channel or the like is not established, the processor 114 may allow only a security operation to be performed without a subscriber authentication operation. In this way, it is possible to effectively reduce computation time.

The memory 115 may store data required for an authentication operation. Also, the memory 115 may include computer-readable instructions. When the instructions stored in the memory 115 are executed, the processor 114 may perform the foregoing operations. The memory 115 may be a volatile memory or a non-volatile memory. The memory 115 may include a storage device for storing data of a user. The storage device may be an embedded multimedia card (eMMC), a solid-state drive (SDD), a universal flash storage (UFS), or the like. The storage device may include at least one non-volatile memory device. The non-volatile memory device may be a NAND flash memory, a vertical NAND (VNAND), a NOR flash memory, a resistive random-access memory (RRAM), a phase-change RAM (PRAM), a magnetoresistive RAM (MRAM), a ferroelectric RAM (FRAM), a spin transfer torque (STT)-RAM, or the like.

The electronic device 110 may additionally include a communication module (not shown).

The communication module (not shown) may perform external communication with the security module 112. The communication module (not shown) may perform various communication operations for short-range communication, long-range communication, wired communication, wireless communication, or the like.

Referring to FIG. 4, an operating method according to an exemplary embodiment may include an operation S310 of receiving a control signal for at least one of the identification function and the security function through the interface part, an operation S320 of transmitting the control signal to the security module, and an operation S330 of transmitting the control signal to the identification module after a certain time when the security module does not operate.

The electronic device (e.g., the processor which will be described below as the electronic device) according to an exemplary embodiment may receive various data or packets through the interface part. Each of the following operations may be processed by the processor unless otherwise described. For example, the electronic device may receive a control signal (corresponding to the foregoing data or packets) for at least one of the identification function and the security function through the interface part (S310).

Subsequently, the electronic device may transmit the received control signal or packets to the security module (S320). In other words, the electronic device may allow the received control signal or packets to be used in the security module. For example, when there is a packet received through the first interface (e.g., I²C), the electronic device may allow the packet to be used first in an RoT security chip which is the security module, and then executed or used in the identification module (e.g., eSIM) after a certain time elapses.

Subsequently, the electronic device may transmit the packets or the control signal to the identification module after the certain time elapses (S330). For example, the certain time may be 100 ms to 1000 ms.

According to a modified example, when packets or a control signal is received after secured communication with the external device, the electronic device may transmit the packets or the control signal to the identification module first rather than the security module. Subsequently, the electronic device may transmit the data to the security module.

Specifically, the processor may operate in a dual mode (an identification operation mode or a security operation mode). The processor may operate in any one of the security mode through the security module and the identification mode through the identification module. The processor may set a priority order for the security module and the identification module and attempt to transmit received packets to any one module first. As an example, the processor may perform a security operation through the security module. For example, the processor may transmit the received packets to the security module. Accordingly, the processor may encrypt firmware binaries and the OS using a unique identification key which is generated through a PUF. In other words, the security module may encrypt the received packets and perform secure booting, secure update, server authentication, and the like using the encrypted data. Alternatively, the processor may transmit the received packets to the identification module. Then, the processor may receive whether subscriber authentication is successful, data, or the like from the identification module in response to the received packets.

An operating method according to an exemplary embodiment may include an operation of receiving a control signal for at least one of the identification function and the security function through the interface part and an operation of determining whether to transmit the control signal to a first module which is one of the identification module for performing the identification function and the security module for performing the security function.

The operation of determining whether to transmit the control signal may include an operation of transmitting a received first packet to the first module which is the one of the identification module and the security module in order of priority and an operation of transmitting a second packet subsequent to the first packet to a second module or transmitting a re-request for the first packet to the external device when the first module does not operate.

The operation of determining whether to transmit the control signal may include an operation of transmitting the first packet to any one of the identification module and the security module corresponding to an initial packet for the received first packet.

The operation of determining whether to transmit the control signal may include an operation of transmitting the first packet to any one of the identification module and the security module corresponding to an initial packet for the received first packet.

Specifically, according to an exemplary embodiment, the processor may first execute a recently or previously executed mode. For example, although the first interface and the second interface may both be available, a previously or immediately used/executed interface (or module) may be used first. When a module corresponding to the previously executed mode fails to transmit a received packet, the processor may execute the other mode. In other words, when a packet (e.g., a current packet or the first packet) is received, the processor may transmit the current packet to a past module which has transmitted a past packet (or the preceding packet) received immediately before the current packet. The past module may be any one of the identification module and the security module. The current packet may be transmitted to the first module. In this example, the first module may correspond to the past module.

Subsequently, when feedback or the like for the first packet is not received from the first module receiving the first packet, the processor may wait for the next packet or request the external device to retransmit the current packet. For example, when operation of the first module is not detected, the processor may not perform any operation until the next packet (second packet) which is a packet subsequent to the current packet is received. When the next packet (second packet) is received, the processor may transmit the next packet to the second module which is not the first module. For example, when the identification module does not operate or feedback or data indicating that a subscriber authentication operation of the identification module has been performed is not received after the current packet is transmitted to the identification module, the processor may not perform any operation until the next packet is received. When the next packet is received, the processor may allow the next packet to be transmitted to the security module rather than the identification module.

Also, when operation of the first module is not detected, the processor may transmit a request for transmission of the next packet or retransmission of the current packet to the external device or the like. Then, the processor may transmit the next packet (the retransmitted current packet or the new packet) from the external device to the second module first.

Further, when the second module does not operate for the next packet or the second packet, the processor may operate to transmit a packet (third packet) subsequent to the next packet to the identification module and the security module.

According to another modified example, the electronic device or processor may include a preprocessing part or a preprocessing module that receives an initial packet to determine one mode in the dual mode. The preprocessing part or preprocessing module in the processor may determine the mode on the basis of a value requested by the external device. In other words, a first packet may be transmitted to a module corresponding to the initial packet to perform an identification or security operation. For example, module compatibility may vary depending on the value of the initial packet. As an example, when a value or packet requested by the external device is “0x00,” the identification mode may be executed first. In other words, the corresponding packet may be transmitted to the identification module. When a value or packet requested by the external device is “0x01,” the security mode may be executed first. In other words, the corresponding packet may be transmitted to the security module.

In this way, a mode may be determined on the basis of the initial packet or initial data of a current packet or a first packet.

According to an exemplary embodiment, when the processor operates in the identification mode (e.g., a SIM mode) or the security mode (a security chip mode) through a normal booting process, the processor may execute the mode most recently successfully executed for a subsequent booting. When the processor fails to boot with an operation most recently successfully performed, the processor may return to a stage for mode selection and select a different mode from the successfully executed mode. For example, when a packet is received in the dual mode and the identification mode (SIM mode) is successful (an identification operation is performed), the packet may be transmitted only in the identification mode (SIM only mode). However, when the processor fails to boot while transmitting packets only in the identification mode, the processor may return to the dual mode and perform the operation.

Alternatively, the other mode (security mode) in the dual mode may be executed. When the processor fails to boot in the other mode, the processor may return to the dual mode and perform the operation.

According to an exemplary embodiment, the various operating methods described above may be performed by the processor. The operating methods according to the disclosed embodiments may be implemented in the form of program instructions that are executable by various computing means, and recorded on a computer-readable recording medium. Also, an embodiment of the present disclosure may be a computer-readable recording medium on which one or more programs including instructions for implementing the operating methods.

The exemplary embodiments described above may be implemented as hardware components, software components, and/or a combination of hardware components and software components. For example, devices, methods, and components described in the exemplary embodiments may be implemented using a processor, a controller, an arithmetic logic unit (ALU), a digital signal processor, a microcomputer, a field programmable gate array (FPGA), a programmable logic unit (PLU), a microprocessor, or a general-purpose computer or a special-purpose computer such as a device that may execute instructions and respond. A processing device may execute an OS or software applications executed on the OS. Also, the processing device may access, store, manipulate, process, and generate data in response to the execution of software. In some cases, to facilitate understanding, it is described that one processing device is used. However, those of ordinary skill in the art should recognize that the processing device may include a plurality of processing elements and/or a plurality of types of processing elements. For example, the processing device may include a plurality of processors or one processor and one controller. Also, the processing device may have another processing configuration such as a parallel processor.

Software may include computer programs, code, instructions, or one or more combinations thereof, and may configure the processing device to operate as desired or instruct the processing device independently or collectively. Software and/or data may be interpreted by the processing device or permanently or temporarily embodied in any type of machines, components, physical devices, virtual equipment, computer storage media or devices, or signal waves to be transmitted to provide instructions or data to the processing device. The software may be distributed on a computer system connected through a network and may be stored or executed in a distributed manner.

The computer-readable recording medium may include program instructions, data files, data structures, and the like solely or in combination. The program instructions recorded on the medium may be those specially designed and constructed for the present invention or well known and available to those skilled in the computer software field. Examples of the computer-readable recording medium include magnetic media such as a hard disk drive (HDD), a floppy disk, and magnetic tape, optical media such as a compact disc read-only memory (CD-ROM) and a digital versatile disc (DVD), magneto-optical media such as a floptical disk, and hardware devices specially configured to store and execute the program instructions such as a ROM, a RAM, a flash memory, and the like. Examples of the program instructions include not only machine code produced by a compiler but also high-level language code that is executable by a computer using an interpreter or the like.

A machine-readable storage medium may be provided in the form of a non-transitory storage medium. Here, the term “non-transitory” means that the storage medium does not include a signal (e.g., electromagnetic waves) and is tangible, but does not distinguish whether data is permanently or temporarily stored in the storage medium. For example, a “non-transitory storage medium” may include a buffer in which data is temporarily stored.

The operating methods according to the various embodiments disclosed herein may be provided in a computer program product. The computer program product may be traded between a seller and a purchaser as a commodity. The computer program product may be distributed in the form of a machine-readable storage medium (e.g., a CD-ROM) or distributed online (e.g., downloaded or uploaded) directly between two user devices (e.g., smartphones) through an application store (e.g., PlayStore™). In the case of online distribution, at least a portion of the computer program product may be stored at least temporarily in a storage medium, such as a memory of a manufacturer's server, an application store's server, or a relay server, or may be temporarily generated therein.

Specifically, the operating methods according to the disclosed embodiments may be provided as a computer program product including a recording medium on which a program for implementing the methods is recorded.

Although exemplary embodiments have been described in detail above, the scope of the present invention is not limited thereto, and various modifications and alterations made by those skilled in the art from the spirit of the present invention defined in the following claims also fall within the scope of the present invention.

As used herein, the term “part” refers to a software or hardware component, such as an FPGA or application-specific integrated circuit (ASIC), which performs certain roles. However, the term “part” is not meant to be limited to software or hardware. A “part” may be included in an addressable storage medium or configured to operate one or more processors. Therefore, as an example, a “part” includes components, such as software components, object-oriented software components, class components, and task components, processes, functions, attributes, procedures, subroutines, segments of program code, drivers, firmware, microcode, circuitry, data, databases, data structures, tables, arrays, and variables. Functionality provided in components and “parts” may be combined into fewer components and “parts” or may be further subdivided into additional components and “parts.” In addition, components and “parts” may be implemented to operate one or more CPUs in a device or a secure multimedia card.

According to exemplary embodiments of the present invention, it is possible to implement an electronic device that has an interface part including interfaces having different protocols in the same chip, that is, combined in hardware, and thus is inexpensive and simultaneously achieves security enhancement and subscriber authentication, and an operating method of the same.

According to exemplary embodiments, it is also possible to implement an electronic device that simultaneously achieves security and subscriber authentication using a physically unclonable value and thus is easy to manufacture, and an operating method of the same.

According to exemplary embodiments, it is also possible to compact a device by providing an interface compatible with an identification module for subscriber authentication and an RoT security module in which the identification module and the security module are not separated into independent chips or devices.

Various advantages and effects of the present invention are not limited to those described above and may be easily understood from the above process of describing specific embodiments of the present invention.

Although exemplary embodiments of the present invention have been mainly described, these are merely illustrative and do not limit the present invention, and those of ordinary skill in the art should know that various modifications and applications not illustrated above can be made without departing from the essential characteristics of the exemplary embodiments. For example, each component specified in an embodiment can be implemented in a modified form. In addition, differences of the modifications and applications are construed as falling within the scope of the present invention defined in the following claims.

What is claimed is:

1. An electronic device comprising:
a memory;
an interface part including a first interface and a second interface having different connection methods;
a processor operationally connected to at least one of the interface part and the memory;
an identification module connected to the second interface to perform subscriber authentication; and
a security module connected to the first interface on the basis of a generated unique identification key to perform a security function.

2. The electronic device of claim 1, wherein the security module includes a physically unclonable function (PUF) chip configured to generate the unique identification key.

3. The electronic device of claim 1, wherein the identification module and the security module operate independently of each other.

4. The electronic device of claim 1, wherein the processor performs subscriber authentication after a certain time when the security function is performed.

5. The electronic device of claim 1, wherein the first interface includes an inter-integrated circuit (I²C) interface and a serial peripheral interface (SPI).

6. The electronic device of claim 1, wherein the second interface includes an International Organization for Standardization (ISO) interface and an International Electrotechnical Commission (IEC) interface.

7. The electronic device of claim 1, wherein the processor turns on or off only operation of at least one of the identification module and the security module.

8. The electronic device of claim 7, wherein the processor transmits a received first packet to a past module that has executed a packet received immediately before the first packet between the identification module and the security module.

9. The electronic device of claim 7, wherein the processor transmits a received first packet to a first module which is any one of the identification module and the security module in order of priority, and
when the first module does not operate, the processor transmits a second packet subsequent to the first packet to a second module or transmits a re-request for the first packet to an external device.

10. The electronic device of claim 7, wherein the processor transmits a received first packet to any one of the identification module and the security module corresponding to an initial packet for the first packet.

11. An operating method of an electronic device, the method comprising:
receiving a control signal for at least one of an identification function and a security function through an interface part;
transmitting the control signal to a security module; and
when the security module does not operate, transmitting the control signal to an identification module after a certain time elapses.

12. The operating method of claim 11, wherein the interface part includes a first interface and a second interface having different connection methods.

13. The operating method of claim 11, wherein the security module includes a physically unclonable function (PUF) chip configured to generate a unique identification key.

14. The operating method of claim 11, wherein the identification module and the security module operate independently of each other.

15. The operating method of claim 11, wherein the transmitting of the control signal to the identification module comprises performing subscriber authentication by transmitting the control signal to the identification module after the certain time elapses.

16. The operating method of claim 11, further comprising turning on or off only operation of at least one of the identification module and the security module.

17. An operating method of an electronic device, comprising:
receiving a control signal for at least one of an identification function and a security function through an interface part; and
determining whether to transmit the control signal to a first module which is one of an identification module for performing the identification function and a security module for performing the security function.

18. The operating method of claim 17, wherein the determining of whether to transmit the control signal comprises:
transmitting a received first packet to the first module which is the one of the identification module and the security module in order of priority; and
when the first module does not operate, transmitting a second packet subsequent to the first packet to a second module or transmitting a re-request for the first packet to an external device.

19. The operating method of claim 17, wherein the determining of whether to transmit the control signal comprises transmitting a received first packet to the one of the identification module and the security module corresponding to an initial packet for the first packet.

20. The operating method of claim 17, wherein the determining of whether to transmit the control signal comprises transmitting a received first packet to the one of the identification module and the security module corresponding to an initial packet for the first packet.
